(19) United States
(12) Patent Application Publication
(10) Pub. No.: US 2026/0077424 A1
(43) Pub. Date: Mar. 19, 2026

(54) SPOT WELDING METHOD

(71) Applicant: GAMING ENGINEERING, LEROUVILLE (FR)

(72) Inventor: Alex GROJEAN, COMMERCY (FR)

(21) Appl. No.: 19/112,348

(22) PCT Filed: Sep. 15, 2023
(86) PCT No.: PCT/FR2023/051410

§ 371 Date: Jul. 29, 2025

(30) Foreign Application Priority Data
Sep. 16, 2022 (FR) 2209326

(51) Int. Cl. B23K 11/11; B23K 11/00; B23K 11/24; B23K 101/00; B23K 103/04; B23K 103/10

(52) U.S. Cl. CPC B23K 11/115; B23K 11/0066; B23K 11/241; B23K 2101/006; B23K 2103/04; B23K 2103/10

(57) ABSTRACT

The present disclosure concerns a spot welding method, including the following steps of: arranging two electrically conductive parts to be assembled between two electrodes, each of the two parts having an interface zone between the two parts and a contact zone with one of the two electrodes; establishing a first electric current between the two electrodes through the two parts, the first electric current producing thermal energy capable of forming a weld nugget within the two parts; and adjusting a distribution of the thermal energy density produced by the first electric current based on the intrinsic characteristics of each of the two parts, to generate a weld nugget initiation zone at a selected depth in the parts to be assembled.

### CROSS REFERENCE TO RELATED APPLICATIONS

This application is a National Stage of PCT Application No. PCT/FR2023/051410 filed on Sep. 15, 2023, which claims priority to French Patent Application No. FR 2209326 filed on Sep. 16, 2022, the contents each of which are incorporated herein by reference thereto.

### TECHNICAL FIELD

The present disclosure concerns the assembly of metal parts, and in particular the assembly of sheet metal using the spot welding technique. The spot welding is used in many sectors, primarily in the automotive industry, and particularly in the aeronautics and railway sectors, to assemble steel parts, and increasingly, aluminum parts.

### BACKGROUND

The spot welding generally consists of placing the parts to be welded between two electrodes with low thermal and electrical resistance, which maintain a high pressure, in the range of a few kN. By establishing a strong electrical current, in the range of tens of kA, between the two electrodes, electrical energy is supplied to the parts to be welded, which heat up locally through the Joule effect. If the electrical current is sufficient, this thermal energy input locally heats the parts to be welded near their interface, forming a weld nugget. The spot welding therefore has the advantage of requiring neither shielding gas nor filler material.

However, the distribution of thermal energy within the parts to be welded, between the electrodes, depends on many factors, such as the thickness and intrinsic resistivity of each of the parts to be welded, as well as the surface conditions (contact resistivity) of the contact zones of the two parts to be welded with the electrodes and at the interface between the two parts to be welded. Furthermore, the two parts to be welded may have different melting temperatures, so the thermal energy input should be greater in the part to be welded with the higher melting temperature. The thermal energy distribution favorable to the formation of a weld nugget centered on the interface between the two parts to be welded can therefore vary significantly depending on the intrinsic characteristics of the parts to be welded. Under these conditions, the weld nugget is initiated in an unselected zone, and the duration of electrical energy input is increased so that the weld nugget extends across the interface between the two parts to be welded. This can therefore result in excessive power consumption. Furthermore, the weld nugget may be just tangent to the interface between the two parts due to due to insufficient duration of electrical energy input. The parts to be assembled may appear to be bonded together, without the parts being welded together. Moreover, an excessive electrical energy input can lead to the formation of cavities in the parts to be assembled and a deterioration in their mechanical strength. These disadvantages can limit the range of possible applications for the spot welding technique.

In some applications, an insert is used to assemble a part, for example a non-metallic part, to a metal part. The insert is inserted into an orifice formed in the non-metallic part and then welded to the metal part so as to hold the non-metallic part against the metal part. If the thermal energy is not properly distributed, the tip of the insert may collapse under the effect of this thermal energy without the metal part melting.

It may therefore be desirable to be able to adapt the thermal energy distribution provided by the electrodes according to the intrinsic characteristics of the parts to be welded, particularly in order to obtain a spot welding of the required quality while reducing the required electrical energy. It may also be desirable to extend the potential uses of the spot welding technique to materials other than steel and aluminum, and to parts other than thin sheet metal.

### BRIEF SUMMARY

Embodiments concern a spot welding method, comprising steps consisting of: arranging two electrically conductive parts to be assembled between two electrodes, each of the two parts having an interface zone between the two parts and a contact zone with one of the two electrodes, and establishing a first electric current between the two electrodes through the two parts, the first electric current producing thermal energy capable of forming a weld nugget within the two parts, characterized in that it comprises a step of adjusting a distribution of thermal energy density produced by the first electric current according to intrinsic characteristics of each of the two parts, to generate a weld nugget initiation zone, at a selected depth in the parts to be assembled.

By adapting the distribution of thermal energy provided by the electric current flowing between the electrodes, based on the intrinsic characteristics of the parts to be welded, it is possible to generate a weld nugget initiation zone at a depth corresponding to the contact surface between the parts to be assembled and thus achieve a robust spot weld, without damaging the parts, while reducing the required electrical energy. In what follows, the term «depth» is used to designate the distance between a point in the parts to be assembled on the common longitudinal axis of the electrodes and the contact surface of one of the electrodes.

According to one embodiment, adjusting the resistivity differential of the electrodes comprises covering the contact surface of one of the electrodes with a fixed or removable layer, made of a material having a resistivity that makes it possible to obtain the adjusted resistivity differential.

According to one embodiment, adjusting the thermal energy density distribution comprises a step of selecting electrodes having different contact surfaces to adjust a differential between the contact surfaces of the electrodes and the two parts.

Thus, the thermal energy distribution can be easily adjusted in the parts to be assembled to form the spot welding.

According to one embodiment, adjusting the thermal energy density distribution comprises a step of selecting electrodes having different contact surface resistivities to adjust a differential between the contact surface resistivities between the electrodes.

According to one embodiment, adjusting the thermal energy density distribution comprises a step of selecting electrodes having different resistivities to adjust a differential between the electrodes.

Adjusting the differential between the electrode resistivities makes it possible to obtain a high-quality spot welding with a wide range of parts having intrinsic characteristics that can be very different.

According to one embodiment, the electrode resistivity differential is adjusted using at least one of the following methods: by using electrodes made of materials exhibiting the adjusted resistivity differential, covering the contact surface of one of the electrodes with a fixed or removable layer of a material exhibiting a resistivity that allows obtaining the adjusted resistivity differential, and inserting a layer of material exhibiting a resistivity that allows obtaining the adjusted resistivity differential into one of the electrodes.

The variety of methods for adjusting the resistivity differential between the electrodes makes it possible to adapt the spot welding system to numerous applications, while reducing the costs of this adaptation.

According to one embodiment, the intrinsic characteristics of each of the two parts comprise at least one of the following characteristics: thickness, resistivity, and melting temperature.

According to one embodiment, the adjustment of the thermal energy density distribution comprises steps consisting of: using, for one of the two electrodes, a multiple electrode formed of at least two electrode parts electrically insulated from one another, the first electric current being established between one of the electrode parts and the other of the two electrodes, and establishing a second electric current between the two electrode parts via the parts to be assembled to form a first weld nugget facing one of the two electrode parts.

The use of such an electrode with two insulated electrode parts has the advantage of allowing the distribution of the thermal energy density to be dynamically adjusted, without having to change an electrode or associate it with a layer of more resistive material.

According to one embodiment, the method further comprises a step of reversing the second current between the two electrode parts to extend the weld nugget towards a zone facing the other of the two electrode parts.

The combination of the steps of applying the second current and reversing this current makes it possible to obtain a weld nugget extending over a surface corresponding to the contact surface of the electrodes, without increasing the welding time.

According to one embodiment, the step of reversing the second current between the two electrode parts is performed multiple times.

According to one embodiment, the method further comprises a step of adjusting the electrical energy supplied by each of the first and second electrical currents to form the ignition zone of the weld nugget at a depth in the parts depending on a differential in the electrical energies supplied by the first and second electrical currents.

This arrangement makes it possible to dynamically adjust the depth of the weld nugget in the stack of parts to be assembled.

According to one embodiment, the adjustment of the thermal energy density distribution comprises the following steps: using a multiple electrode formed from at least two electrode parts electrically insulated from one another for the other of the two electrodes; selecting an electrode part among the two electrodes; and applying a voltage polarity to the selected electrode part and applying a reverse voltage polarity to the non-selected electrode parts.

The use of a second double electrode makes it possible to reach any depth in the stack of parts to be assembled to form the weld nugget.

According to one embodiment, the two parts to be assembled belong to a stack of more than two parts, the method comprising several successive steps of adjusting the electrical energy supplied by each of the first and second electric currents to adjust the depth of the weld nugget initiation zone in the stack, in order to extend the weld nugget to the interfaces between the parts of the stack.

The use of a second double electrode and the implementation of several spot welding steps by readjusting the formation depth of the weld nugget at each step makes it possible to quickly perform a spot welding through a stack of more than two parts to be assembled.

According to one embodiment, one of the two parts to be assembled is an insert disposed in an orifice of a third part to be assembled to assemble the third part to the other of the two parts to be assembled.

Thus, it is possible to assemble a non-electrically conductive part with a conductive part using the spot welding technique, while ensuring good welding quality and without the risk of damaging the non-conductive part due to excess heat or pressure.

Embodiments may also concern a spot welding system comprising two electrodes, to be applied against two opposite faces of a stack of parts to be assembled, the system being configured to implement the method as defined above.

According to one embodiment, the electrodes have a contact surface differential, and/or the electrodes have a resistivity differential of contact surfaces with the parts to be assembled, and/or the electrodes have a resistivity differential, and/or at least one of the electrodes comprises two electrode parts electrically insulated from one another and connected so as to each receive a respective voltage.

According to one embodiment, one of the two electrodes has one of the following characteristics: is made of a material having a resistivity greater than the resistivity of the other electrode, has a contact surface covered with a fixed or removable layer, made of a material having a resistivity greater than the resistivity of the electrode, and comprises a housing in which is inserted a material having a resistivity greater than the resistivity of the electrode.

### BRIEF DESCRIPTION OF THE FIGURES

The present disclosure will be better understood with the aid of the following description of exemplary embodiments with reference to the appended figures, in which identical reference signs correspond to structurally and/or functionally identical or similar elements.

FIG. 1 schematically shows a cross-sectional view of two parts to be assembled, arranged one against the other between two spot welding electrodes, according to the prior art,

FIGS. 2 to 8 schematically show a cross-sectional view of two parts to be assembled, arranged one against the other between two spot welding electrodes, according to various embodiments,

FIGS. 9A, 9B, 9C schematically show a cross-sectional view of two parts to be assembled, arranged one against the other between two spot welding electrodes, according to another embodiment,

FIG. 10 schematically shows a cross-sectional view of two parts to be assembled, arranged one against the other between two spot welding electrodes, according to another embodiment,

FIGS. 11A, 11B, 11C schematically show a cross-sectional view of two parts to be assembled, arranged one against the other at different steps of an assembly method, according to another embodiment,

FIGS. 12A, 12B schematically show a cross-sectional view of two parts to be assembled together at different steps of an assembly method, according to another embodiment.

### DETAILED DESCRIPTION

FIGS. 1 to 8 show two parts to be assembled P1, P2 arranged one against the other between two spot welding electrodes E1, E2, E11, E12, E21-E26 aligned along an axis Z. FIG. 1 illustrates a spot welding method according to the prior art. In the examples of FIGS. 1 to 8, parts P1, P2 have the shape of plates represented horizontally, with a contact surface S3 at the interface between the two parts. The part P1, shown in the figures in the upper position, has a thickness less than part P2, shown in the lower position. The upper electrode E1, E11, E21-E26 is therefore placed against the upper part P1 and has a contact surface S1 with part P1. The lower electrode E2, E12 is placed against the lower part P2 and has a contact surface S2 with the part P2.

To assemble the two parts P1, P2 together using the spot welding technique, the parts are electrically conductive, and the electrodes E1, E2, E11, E12, E21-E26 are subjected to a voltage, so as to cause an electric current to flow from one electrode to the other. The passage of current through the parts P1, P2 produces more or less local heating, depending on the resistivity of the regions crossed by the current. These resistive regions comprise:
the electrodes E1, E2, E11, E12, E21-E26 which are made of materials with low resistivities R1, R7, for example copper,
the contact surfaces S1, S2 between the electrodes and the parts P1, P2 to be assembled, whose respective resistivities R2, R6 depend on the pressure exerted by the electrodes and the condition of the contacting surfaces,
the parts P1, P2 to be assembled having resistivities R3, R5 respectively, and
the contact surface at the interface S3 between the parts to be assembled, whose resistivity R4 depends on the pressure exerted by the electrodes and the condition of the contacting surfaces.

The respective resistivities R2, R4, and R6 of the contact surfaces S1, S2, and S3 are partly related to the pressure exerted by the electrodes E1 and E2, which can reach several kN.

The heating produced by the Joule effect by the passage of current between the electrodes E1, E2, E11, E12, E21-E26 and in the parts P1 and P2 forms a thermal energy density distribution in the parts P1 and P2, promoting the formation of a weld nugget initiation zone in the parts to be assembled. When the temperature of this initiation zone reaches the melting temperature of the part in which it is located, a weld nugget WN is developed in and around this zone, in which the materials constituting the parts melt. The assembling of the two parts P1, P2 is achieved when the weld nugget WN extends to both parts through the contact surface S3, which implies that the ignition zone has reached or exceeded the melting temperatures of the two parts.

FIGS. 1 to 8 represent the relative values of the resistivities R1-R7, and the values of the current densities 11, 12, 13 across the contact surfaces S1, S2 and the interface S3.

In FIG. 1, the contact surfaces of electrodes E1, E2 are identical. As a result, the density of thermal energy generated by the Joule effect can be distributed to form a weld nugget initiation zone located on the median plane PM at equal distances from the contact surfaces S1, S2 between the parts P1, P2 and the electrodes E1, E2. If the parts P1, P2 have different thicknesses, identical resistivities and identical melting temperatures, the distribution of thermal energy can generate a weld nugget WN in a zone far from the interface zone S3 between the two parts P1, P2, where it is desirable to form the weld nugget to ensure the attachment of parts P1, P2 to each other. As a result, the current between the electrodes will have to be supplied for a longer time to allow the weld nugget to extend and reach the other part P1 through the interface zone S3.

In the example of FIG. 1, the resistivities R1, R7 of the electrodes E1, E2 are low, the resistivities R2, R6 of the contact surfaces S1, S2 are slightly higher, the resistivity R3 of the part P1 is substantially identical to the resistivity R2 of the contact surface S1, the resistivity R5 of the part P2 is greater than that of the part P1, and the resistivity of the interface S3 is substantially identical to that of the part P2. The current densities 11, 12, 13 are substantially identical at the interfaces S1, S2, S3.

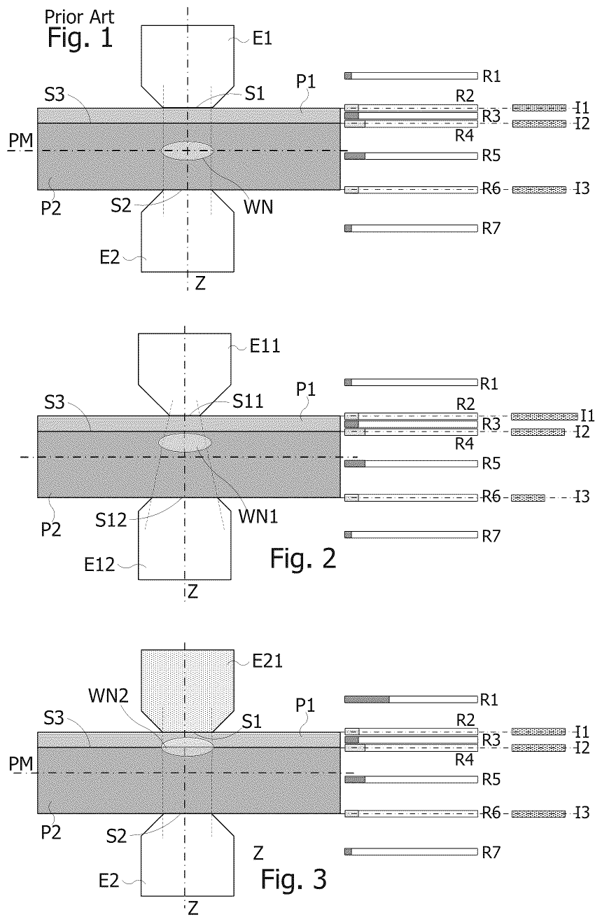

According to an embodiment illustrated by FIG. 2, the electrodes E11, E12 differ from the electrodes E1, E2 in that they have different respective contact surfaces S11, S12 with the parts P1, P2. In the example of FIG. 2, the electrode E11 has the smallest contact surface S11 and is in contact with the part P1 having the smallest thickness. As a result, the current density 11, and therefore the thermal energy density, is higher in the vicinity of the electrode E11 having the smallest contact surface S11. The current density 13 is lower in the vicinity of the electrode E12 having the largest contact surface S12. On the other hand, the resistivities R1-R7 are not modified compared to the embodiment of FIG. 1. The ignition zone where the thermal energy is most concentrated is therefore moved towards the electrode E11, which makes it possible to form a weld nugget WN1 at a depth closer to the interface S3 between the two parts P1, P2.

By adjusting the respective contact surfaces of electrodes E11 and E12, it is therefore possible to adjust the position of the ignition zone in the parts P1 and P2, along the common longitudinal axis Z of the electrodes, and therefore the position of the weld nugget WN1 within parts P1, P2 to be assembled.

However, it turns out that the possible displacement of the zone receiving the most thermal energy is limited and may not be sufficient to correctly position the ignition point of the weld nugget, given the thicknesses and melting temperatures of parts P1 and P2, and the resistivities R2 and R6. Furthermore, due to the contact pressure of the two electrodes required to perform a spot welding, an electrode with too small contact surface can deform the part to be assembled with which it is brought into contact, and therefore damage it.

FIG. 3 shows the two parts to be assembled P1, P2 placed against each other between two spot welding electrodes E21, E2. According to one embodiment, the electrode E21 differs from the electrode E1 in that its resistivity R1 is greater than that (R7) of the electrode E2. The current densities 11, 12, 13 are not modified. In this way, the more resistive electrode E21 heats up more by Joule effect than the less resistive electrode E2. As a result, the distribution of thermal energy has a zone receiving the most thermal energy at a depth even closer to the electrode E21 than to the electrode E2. By adjusting the respective resistivities of the electrodes, it is therefore possible to adjust the position of the weld nugget ignition zone WN2 within the parts P1, P2 to be assembled so that it is generated on or near the interface S3 between the parts P1, P2.

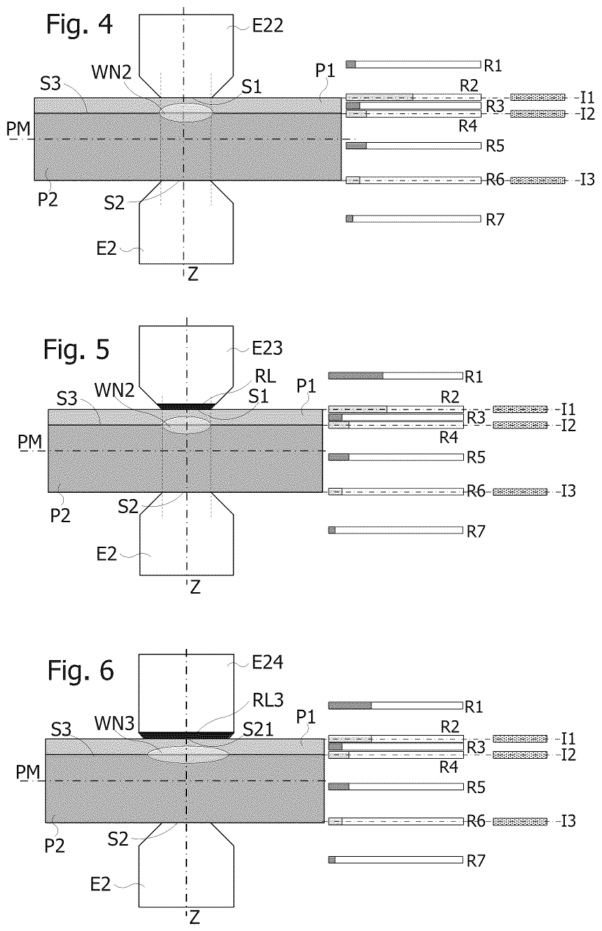

Such a result can also be obtained in the embodiments illustrated in FIGS. 4 to 8.

In FIG. 4, the resistivity R2 of the contact surface S1 of the upper electrode E22 is increased, for example by increasing the roughness of the electrode surface so that only a part of the surface of the electrode E22 is in contact with the part P1.

In FIG. 5, the resistivity R1 of the upper electrode E23 is increased by placing a resistive layer RL on the contact surface S1 of the electrode E23. The resistive layer RL is formed from a more resistive material than the material constituting the electrodes E23, E2. The resistivity of the resistive layer RL can be adjusted by the choice of its material and its dimensions, so that the ignition zone of the weld nugget WN2 within the parts P1, P2 to be assembled is located on or near the interface S3 between the parts P1, P2. The presence of the resistive layer at the interface between the electrode E23 and the part P1 can have the effect of increasing the resistivity R2 of the contact surface S1.

The upper electrode E24 in FIG. 6 differs from that (E23) in FIG. 5 in that its contact surface S21 is larger than the contact surface S2 of the lower electrode E2. The resistive layer RL3 can also be enlarged to cover the entire contact surface S1 of the electrode E24. This arrangement allows obtaining an enlarged weld nugget WN3. It should be noted here that the increase in resistivity R1 obtained by the resistive layer RL3 largely compensates for the increase in contact surface S21 and allows the weld nugget WN3 to be formed near the interface between the two parts P1, P2, even if the lower part P2 is thicker than the upper part P1.

In FIG. 7, the resistivity R1 of the upper electrode E25 is increased by inserting a resistive material RL1 into a recess located near the contact surface S1 of the electrode E25. In this way, the surface finish of the electrode E25 can be identical to that of the electrode E2. The resistivity of the resistive insert RL1 can also be adjusted for the same purpose as in the embodiment of FIG. 5.

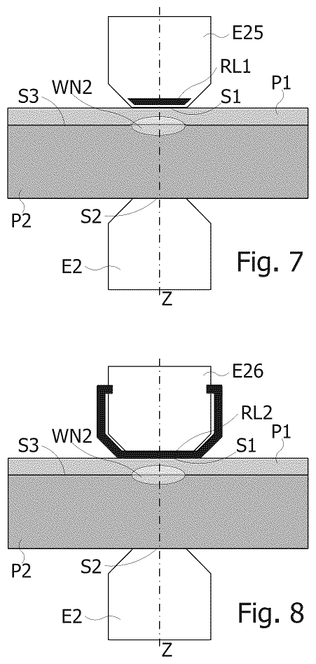

The upper electrode E25 of FIG. 8 differs from that (E23) of FIG. 5 in that the resistive layer RL of the upper electrode is replaced by a removable part RL2 capable of being attached so as to cover the contact surface S1 of the electrode E25. The part RL2 is formed from a more resistive material than the material constituting the electrodes E25, E22. The part RL2 is, for example, attached by clips to the electrode E25.

The resistive layer RL, RL3 can be made, for example, of steel, aluminum, bronze, or nickel. It can be formed on the contact surface of the electrode by a metallization method such as the cold spray method. The cold spray method consists of projecting a metal powder at high speed using a pressurized, high-temperature gas (up to 50 bars and 1100° C.) onto the surface to be coated, the impact force ensuring the quality of the deposit. For this purpose, a convergent-divergent nozzle (De-Laval type) transforms the temperature and pressure of the gas into kinetic energy, causing its acceleration to supersonic speed and its cooling to a temperature below 100° C. The metal powder is injected into the high-pressure zone of the nozzle, where the metal particles are accelerated to speeds of up to 1200 m/s. The deformation of the particles upon impact on the surface to be treated allows for very high-quality coatings to be obtained, with strong adhesion and no oxidation.

The nature of the metal forming the metal powder is selected to adjust the resistivity differential of the electrodes. The contact surface of the removable part RL2 can also be treated using such a metallization method.

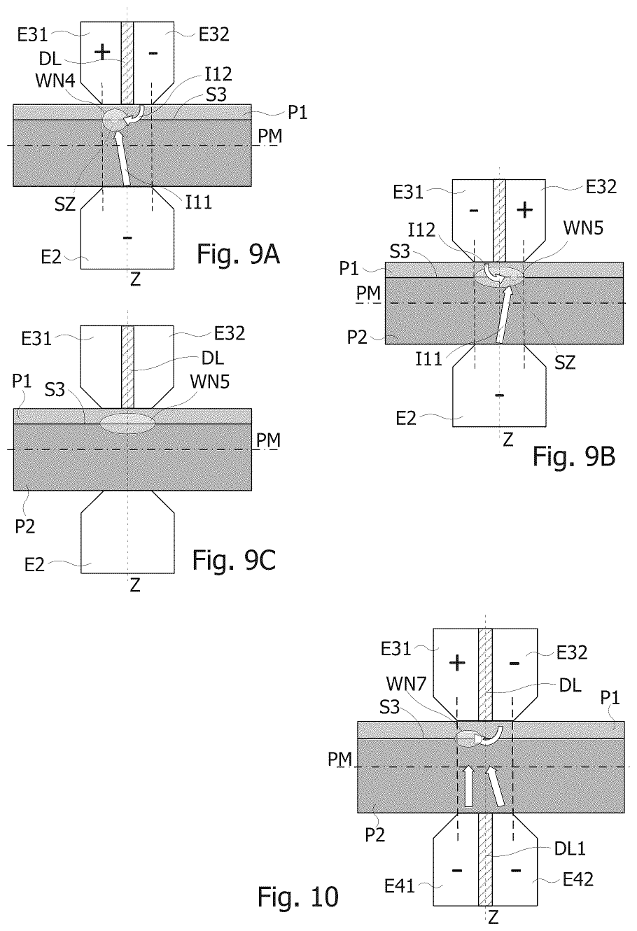

FIGS. 9A, 9B, and 9C illustrate a method for assembling parts P1, P2 by spot welding, according to another embodiment. FIGS. 9A, 9B, and 9C represent the two parts P1, P2 arranged against each other and between two electrodes E31/E32 and E2. In particular, these figures represent the parts P1 and P2 to be assembled in the form of horizontal plates, with the upper part P1 having a thickness less than the lower part P2. The electrodes therefore comprise an upper electrode E31/E32 arranged above the parts to be assembled and a lower electrode E2 arranged below the parts to be assembled. According to one embodiment, the electrode E31/E32 is a double electrode comprising two electrodes (or two electrode parts) E31 and E32 separated by an electrically insulating layer DL. In this way, the electrode parts E31 and E32 can be subjected to different voltages. The electrode parts E31 and E32 and the insulating layer can be assembled, for example, by a ring arranged around the assembly. The insulating layer can be made of a dielectric material that is stable at the temperatures to which the electrodes are subjected. This dielectric material can be, for example, a calcium silicate-based composite material, a geopolymer, PTFE (polytetrafluoroethylene), PPS (polyphenylene sulfide), PAI (polyamide-imide), a PSU (polysulfone), alumina, or even a ceramic.

As illustrated in FIGS. 9 and 10, the double electrode E31/E32 has the same external volume as the single electrode E2. As a result, for example, the contact surface of the double electrode E31/E32 can be treated with the same tool as the single electrode E2, particularly to perform a production operation known as «lapping» to remove particles of material torn from the parts to be welded and adhering to the contact surface. The compactness of this embodiment also makes it possible to address the challenges of accessibility to the zones to be assembled, which depends on the size of the electrodes.

FIG. 9A illustrates a step in the assembly method, in which the electrode E31 is subjected to a positive voltage and the electrodes E32 and E2 are subjected to a negative voltage. In this way, a first current 111 is established between the electrodes E2 and E31 through the parts P1, P2, and a second current 112 is established between the electrodes E32 and E31 mainly through the part P1 in contact with the double electrode E31/E32. The two currents 111, 112 form a higher current density zone in the vicinity of the contact surface between the part P1 and the single electrode (E31) subjected to a positive voltage, this higher current density zone being conducive to the formation of an ignition zone SZ of a weld nugget WN4.

FIG. 9B illustrates a step of the assembly method, in which the electrode E32 is subjected to a positive voltage and the electrodes E31 and E2 are subjected to a negative voltage. In this way, the first current 111 is established between the electrodes E2 and E32 through the parts P1, P2, and the second current 112 is established between the electrodes E31 and E32 mainly through the part P1 in contact with the double electrode E31/E32. The combination of the two currents 111, 112 therefore promotes the formation of an ignition zone SZ of a weld nugget near the electrode E32.

FIG. 9C illustrates a final state of an assembly method chaining the steps illustrated by FIGS. 9A and 9B, by exploiting thermal inertia. During the chaining of these steps, the ignition zone SZ is displaced laterally from the electrode E31 to the electrode E32. As a result, the weld nugget WN4 is extended in the direction of the electrode E32 to form a weld nugget WN5 extending to the interface S3 and having the width of the double electrode E31, E32 or the electrode E2. Since the current density obtained in each of these steps is higher than with a single electrode, the duration of the two-step welding operation (FIGS. 9A, 9B) can be shorter at equal voltages than in a single step with two single electrodes with the same contact surfaces. Thus, the method illustrated in FIGS. 9A and 9B allows the direction of expansion of the weld nugget to be controlled. In contrast, in spot welding technique according to the prior art, the duration of the welding operation is extended to allow the weld nugget to expand sufficiently in all directions, without being certain that the weld nugget extends sufficiently across the interface between the parts to be assembled. Such an extension of the welding time results in inefficient energy expenditure and a risk of damaging the parts to be assembled, without guaranteeing the strength of the assembly.

It can be seen that the double electrode E31/E32 can be used as a single electrode by subjecting the electrodes E31 and E32 to the same voltage of positive or negative polarity, while the electrode E2 is subjected to a voltage of reverse polarity. In this way, a current is established between the electrodes E2 and E31/E32 through the parts P1, P2.

According to one embodiment, the steps illustrated by FIGS. 9A, 9B are chained several times by reversing several times the polarities of the voltages applied to the electrodes E31 and E32. According to an exemplary embodiment, the polarities of the voltages applied to the electrodes E31 and E32 are reversed at a frequency of several hundred Hertz (for example 1 kHz) for a duration of several hundred milliseconds (for example 1 s).

According to one embodiment, in the cases illustrated by FIGS. 9A, 9B where the voltages supplied to the electrodes E31 and E32 have reverse polarities, the voltage supplied to the electrodes E2, E31, E32 is modulated so as to adjust the electrical energy supplied by the first current 111 between the electrodes of reverse polarities E2 and E31 (case of FIG. 9A) or E2 and E32 (case of FIG. 9B) on the one hand, and on the other hand the electrical energy supplied by the second current 112 between the electrodes E32 and E31. This adjustment makes it possible to adjust the position of the higher energy density zone and therefore the ignition zone, between the electrode E2 and the double electrode E31/E32. The first current 111 may be zero and the second current 112 non-zero. In this case, the ignition zone SZ of the weld nugget is generated by the second current 112 and is therefore located closest to the double electrode E31/E32. The second current 112 can be zero and the first current 111 non-zero. In this case, the ignition zone of the weld nugget is formed by the first current 111 and is therefore located substantially at equal distances from the contact surfaces S1, S2 of the electrodes E31/E32 and E2, on the median plane PM at equal distances from the contact surfaces S1, S2. Consequently, in the presence of the two currents 111, 112, the ignition zone SZ of the weld nugget is formed between these two extremes in the parts P1, P2, at a distance from the double electrode E31/E32 depending on the ratio between the intensities of these two currents.

The adjustment of the electrical energy supplied by the currents 111, 112 between each pair of electrodes (E31, E2) and (E31, E32) or (E32, E2) and (E32, E31), of opposite polarities can be carried out by applying different modulations to these pairs of electrodes. According to one embodiment, the used modulation can be of the PWM (“Pulse Width Modulation”) type, the electrical energy supplied being adjusted by adjusting the duty cycle of the modulation.

FIG. 10 schematically represents in section the two parts P1, P2 to be assembled arranged one against the other between two spot welding electrodes E31/E32 and E41/E42, according to another embodiment. The embodiment of FIG. 10 differs from that of FIG. 9A in that the two electrodes on either side of the parts P1, P2 to be assembled are double electrodes. Thus, the lower electrode (in FIG. 10) is formed of two electrodes E41 and E42 separated from each other by a layer DL1 made of an electrically insulating material. The provision of two double electrodes makes it possible to generate the weld nugget ignition zone in the vicinity of any of the electrodes E31, E32, E41, E42, and therefore to adjust the position of the weld nugget WN7 to any depth in the parts P1, P2 between the double electrodes E31/E32 and E41/E42. In fact, the weld nugget ignition zone can be located as previously described between the median plane PM located at equal distances from the contact surfaces S1, S2 and the double electrode E31/E32, establishing the first current between the double electrode E41/E42 and the electrode E31 or E32, and the second current between the electrodes E31 and E32. The provision of the double electrode E41/E42 makes it possible to establish the first current between the double electrode E31/E32 and the electrode E41 or E42, and the second current between the electrodes E41 and E42. Thus, the weld nugget initiation zone can be located in the thickness of the parts P1, P2, between the median plane PM of the cumulative thickness of the parts P1, P2 and the contact surface of the double electrode E41/E42.

According to one embodiment, the double electrode E31, E32 can be replaced by a multiple electrode, divided into more than two electrodes separated by electrically insulating layers, one of the electrodes of the multiple electrode being subjected to a first voltage and the other electrodes of the multiple electrode being subjected to a second voltage of opposite polarity, during a step of the welding method. The welding method can then include as many steps as those illustrated in FIGS. 9A and 9B as there are electrodes in the multiple electrode, with the electrode subjected to the first voltage being modified at each step. This arrangement makes it possible to further increase the current density in the vicinity of the electrode subjected to the first voltage.

In the embodiments illustrated in FIGS. 2 to 11, the spot welding method makes it possible to obtain a weld of the required quality while reducing the required electrical energy, with parts to be assembled that may have very different thicknesses, different resistivities, and different melting temperatures. Thus, the welding method can be applied to the assembly of two electrically conductive parts of the same or different compositions, for example, steel, aluminum, copper, titanium, or a nickel alloy, for example of the Inconel® type.

Furthermore, the number of parts to be assembled can be greater than two, with the parts to be assembled forming a stack of parts. The assembly of such a stack can, for example, be achieved by using multiple electrodes as illustrated in FIG. 10, and by varying the formation depth of the welding spot initiation zone to reach all the interfaces between two parts of the stack.

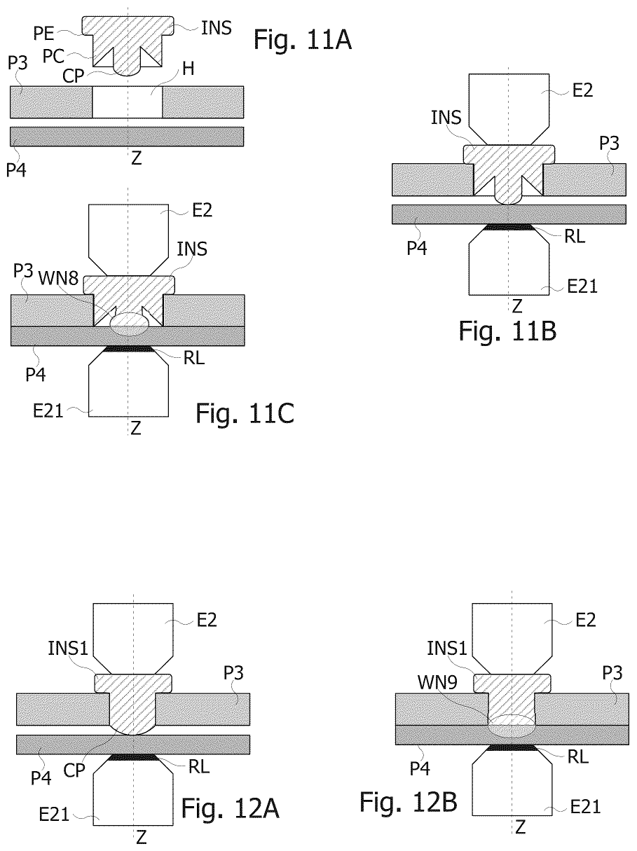

FIGS. 11A, 11B, 11C represent two parts P3, P4 to be assembled together at different steps of an assembly method, according to one embodiment. Part P3 may be made of a material incompatible with the spot welding technique, such as, for example, a non-electrically conductive material, or a material that risks being damaged due to the high temperatures and pressures to which the parts are subjected. An insert INS is used to assemble the parts P3, P4. For this purpose, the insert INS is engaged in a through orifice H formed in part P3. The insert INS comprises a central stud CP intended to be welded onto the part P4 and a peripheral rim PE intended to form a stop when it is inserted into the part P3 and to retain the part P3 after welding the insert to the part P4. The insert INS may also comprise a peripheral collar AC intended in particular to protect the part P3 from high temperatures when welding the stud CP onto the part P4. The collar AC may also be shaped to produce the orifice H when the insert is engaged in the part P3.

In FIG. 11A, the insert INS is engaged in the orifice H formed in the part P3. In FIG. 11B, the assembly formed by the parts P3, P4 and the insert INS is placed between spot welding electrodes, for example the electrodes E21, E2, the resistivity differential between the electrode E21 placed in contact with the part P4 and the electrode E2 placed in contact with the insert INS, being adjusted so that the ignition zone of the weld nugget is formed at a depth corresponding to that of the free end of the stud CP. In FIG. 11C, a current is supplied between the electrodes E21, E2, which makes it possible to form a weld nugget WN8 including the free end of the stud CP which has been deformed under the effect of the thermal energy supplied by the electrodes, and a portion of the part P4 in contact with the stud. The insert INS then holds the parts P3, P4 pressed against each other.

Of course, the depth of the weld nugget initiation zone can also be adjusted using multiple electrodes, as illustrated in FIGS. 9 and 10.

Using such a welded insert, the method can be applied to the assembly of an electrically conductive part, for example, made of steel, aluminum, copper, etc., with a part made of a non-electrically conductive material, such as a resin, polymer, ceramic, or composite material. The insert INS can be formed from a material such as steel or aluminum.

FIGS. 12A and 12B show the two parts P3, P4 to be assembled together at different steps of an assembly method, according to another embodiment. The embodiment illustrated in FIGS. 12A, 12B differs from that of FIGS. 11A-11C in that the insert INS1 used to assemble the parts P3, P4 has a simplified shape without a peripheral collar AC. In FIG. 12B, a current is supplied between the electrodes E21, E2, which makes it possible to form a weld nugget WN9 including the free end of the stud CP which has been deformed, and a portion of the part P4 in contact with the stud. The insert INS1 then makes it possible to keep the parts P3, P4 pressed against each other.

It will be clear to those skilled in the art that the present disclosure is susceptible to various variants and various applications. In particular, the present disclosure is not limited to the presented embodiments, but also covers all technically possible combinations of these embodiments. Thus, an adjustment of the contact surface of one of the electrodes can be combined with an adjustment of the respective resistivities of the electrodes (or the differential of these resistivities) as illustrated by FIGS. 3 to 8. Similarly, in the use of double electrodes illustrated by FIGS. 9A-9C and 10, one of the electrodes formed of at least one double electrode, can have a different contact surface resistivity or a different resistivity from that of the other of the electrodes.

The present description presents provisions which may constitute disclosures in their own right, protectable separately and independently of the scope of the appended claims. Thus, these arrangements comprise:
providing a part RL1 made of a selected material, inserted into one and/or the other of the electrodes, providing a removable part (RL2) made of a selected material, removably attached to one and/or the other of the electrodes, in order to cover the contact surface of the electrode,
providing one or two electrodes including at least two electrode parts assembled together with a dielectric layer disposed between the electrode parts to electrically insulate them from one another,
the various methods for supplying the multiple electrodes described above, and in particular the step of reversing the second current 112 between the two electrode parts E31, E32, repeating this step several times, and adjusting the electrical energy supplied by each of the first and second electric currents 111, 112 to adjust the depth of formation of the weld nugget.

1. A spot welding method, comprising the steps of:
arranging two electrically conductive parts to be assembled between two electrodes each of the two electrically conductive parts having an interface zone between the two electrically conductive parts and a contact zone with one of the two electrodes, and
establishing a first electric current between the two electrodes through the two electrically conductive parts, the first electric current producing thermal energy capable of forming a weld nugget within the two electrically conductive parts, and
adjusting a distribution of thermal energy density produced by the first electric current based on intrinsic characteristics of each of the two electrically conductive parts, to generate a weld nugget initiation zone, at a selected depth in the two electrically conductive parts to be assembled, adjusting a resistivity differential of the two electrodes comprising covering of the contact zone of one of the two electrodes with a fixed layer or a removable layer, made of a material having a resistivity that makes it possible to obtain the adjusted resistivity differential.

2. The method according to claim 1, wherein the adjusting a distribution of thermal energy density comprises a step of selecting electrodes having different contact surfaces, to adjust a differential of contact surfaces of the electrodes with the two electrically conductive parts.

3. The method according to claim 1, wherein the adjusting a distribution of thermal energy density comprises a step of selecting electrodes having different contact surface resistivities to adjust a differential in contact surface resistivities between the two electrodes.

4. The method according to claim 1, wherein the adjusting a distribution of thermal energy density. comprises a step of selecting electrodes having different resistivities to adjust a differential in resistivity between the two electrodes.

5. The method of claim 4, wherein the adjusting a resistivity differential of the two electrodes further comprises one of the following steps:
selecting electrodes from a set of electrodes made of different materials, and
inserting into one of the two electrodes a layer made of a selected material to obtain the adjusted differential in resistivity.

6. The method according to claim 1, wherein the adjusting a distribution of thermal energy density comprises steps consisting of:
using for one of the two electrodes a multiple electrode formed of at least two electrode parts electrically insulated from one another, the first electric current being established between one of the at least two electrode parts and the other of the two electrodes, and
establishing a second electric current between the at least two electrode parts via the two electrically conductive parts to be assembled to form a first weld nugget opposite one of the at least two electrode parts.

7. The method according to claim 6, further comprising a step of reversing the second current between the at least two electrode parts to extend the weld nugget toward a zone facing the other of the at least two electrode parts.

8. The method according to claim 7, wherein the step of reversing the second current between the at least two electrode parts is performed multiple times.

9. The method according to claim 6, further comprising a step of adjusting electrical energy supplied by each of the first and second electrical currents to form the weld nugget initiation zone at a depth in the two electrically conductive parts depending on a differential in the electrical energy supplied by the first and second electrical currents.

10. The method of claim 9, wherein the adjusting a distribution of thermal energy density comprises the steps of:
using for the other of the two electrodes a multiple electrode formed of at least two electrode parts electrically insulated from each other,
selecting an electrode part among the two electrodes, and
applying a voltage polarity to the selected electrode part and applying a reverse voltage polarity to an unselected electrode parts.

11. The method according to claim 10, wherein the two electrically conductive parts to be assembled belong to a stack of more than two electrically conductive parts, the method comprising several successive steps of adjusting the electrical energy supplied by each of the first and second electrical currents to adjust the depth of the weld nugget initiation zone in the stack, in order to extend the weld nugget to the interfaces between the parts of the stack.

12. The method according to claim 1, wherein one of the two electrically conductive parts to be assembled is an insert disposed in an orifice of a third part to be assembled in order to join the third part to the other of the two parts to be assembled.

13. A spot welding system comprising two electrodes, to be applied against two opposite faces of a stack of parts to be assembled, the system being configured to implement the method according to claim 1, a contact surface of one of the electrodes being covered with a fixed layer or a removable layer, made of a material having a resistivity making it possible to obtain an adjusted resistivity differential.

14. The system according to claim 13, wherein:
the two electrodes have a differential contact surface zone, and/or
the two electrodes have a differential resistivity of contact surfaces with the two electrically conductive parts to be assembled, and/or
the two electrodes have a differential resistivity, and/or
at least one of the two electrodes comprises two electrode parts electrically insulated from one another and connected so as to each receive a respective voltage.

15. The system according to claim 13, wherein one of the two electrodes has one of the following characteristics:
is made of a material having a resistivity greater than the resistivity of the other of the two electrodes,
has a contact surface covered with a fixed layer or a removable layer, made of a material having a resistivity greater than the resistivity of the electrode, and
comprises a housing into which is inserted a material having a resistivity greater than the resistivity of the electrode.

16. The method according to claim 2, wherein the adjusting a distribution of thermal energy density comprises a step of selecting electrodes having different contact surface resistivities to adjust a differential in contact surface resistivities between the two electrodes.

17. The method according to claim 16, wherein the adjusting a distribution of thermal energy density comprises a step of selecting electrodes having different resistivities to adjust a differential in resistivity between the two electrodes.

18. The method of claim 17, wherein the adjusting a resistivity differential of the two electrodes further comprises one of the following steps:
selecting electrodes from a set of electrodes made of different materials, and
inserting into one of the two electrodes a layer made of a selected material to obtain the
adjusted differential in resistivity.

19. The method according to claim 18, wherein the adjusting a distribution of thermal energy density comprises steps consisting of:
using for one of the two electrodes a multiple electrode formed of at least two electrode parts electrically insulated from one another, the first electric current being established between one of the at least two electrode parts and the other of the two electrodes, and
establishing a second electric current between the at least two electrode parts via the two electrically conductive parts to be assembled to form a first weld nugget opposite one of the at least two electrode parts.

20. The method according to claim 19, further comprising a step of reversing the second current between the at least two electrode parts to extend the weld nugget toward a zone facing the other of the at least two electrode parts.
